(19) United States
(12) Patent Application Publication
(10) Pub. No.: US 2012/0093697 A1
(43) Pub. Date: Apr. 19, 2012

(54) HONEYCOMB CATALYST BODY AND METHOD FOR MANUFACTURING HONEYCOMB CATALYST BODY

(75) Inventors: Misako Iwakura, Ibi-gun (JP); Kohei Ota, Ibi-gun (JP)

(73) Assignee: IBIDEN CO., LTD., Ogaki-shi (JP)

(21) Appl. No.: 13/252,156

(22) Filed: Oct. 3, 2011

(30) Foreign Application Priority Data
Oct. 13, 2010 (JP) 2010-230194

(51) Int. Cl. B01D 53/86; B32B 37/12; B05D 3/00; B32B 38/10; B05D 5/00; B32B 37/14; B82Y 40/00; B82Y 30/00

(52) U.S. Cl. 422/177; 427/10; 156/60; 156/250; 977/755; 977/890

(57) ABSTRACT

A honeycomb catalyst body includes a honeycomb structure and a catalyst. The honeycomb structure includes a porous honeycomb fired body having at least one cell wall defining a plurality of cells extending along a longitudinal direction of the porous honeycomb fired body. The plurality of cells is provided in parallel with one another. The honeycomb fired body contains silicon carbide particles and a silica layer formed on a surface of each of the silicon carbide particles. The silica layer has a thickness of from about 5 nm to about 100 nm measured by X-ray photoelectron spectroscopy. The catalyst contains at least one of oxide ceramics and zeolite. The catalyst is provided on a surface of the silica layer. An amount of at least one of the oxide ceramics and the zeolite is about 50 g/L or more.

### CROSS-REFERENCE TO RELATED APPLICATIONS

The present application claims priority under 35 U.S.C. §119 to Japanese Patent Application No. 2010-230194, filed on Oct. 13, 2010, the contents of which are incorporated herein by reference in their entirety.

### BACKGROUND OF THE INVENTION

1. Field of the Invention

The present invention relates to a honeycomb catalyst body and a method for manufacturing a honeycomb catalyst body.

2. Discussion of the Background

Recently, particulates (hereinafter, also referred to as PM) such as soot in exhaust gases discharged from internal combustion engines such as diesel engines have raised problems as contaminants harmful to the environment and the human body. Further, there have been concerned about an influence on the environment and the human body by toxic gas components, such as CO, HC, and NOx, also contained in the exhaust gases.

To capture PM and convert toxic gas components in exhaust gases, various honeycomb catalyst bodies have been proposed, which are manufactured by supporting catalysts such as platinum on honeycomb structures made of porous ceramics.

The porous ceramics forming the honeycomb structure may be, for example, a silicon carbide from the standpoint of thermal resistance and chemical resistance.

For example, JP-A 2003-154223 discloses such a honeycomb catalyst body in which a honeycomb structure carries a supporting material such as aluminum so that a catalyst is dispersively supported thereon.

JP-A 2003-154223 discloses formation of a silica layer on the surface of each of the silicon carbide particles forming the honeycomb structure with an aim of accelerating a chemical bond between silicon carbide and aluminum or the like.

JP-A 2003-154223 also discloses that a silica layer is formed by oxidation treatment of a honeycomb structure through heating at from 800° C. to 1600° C. for from 5 hours to 100 hours.

JP-A 2000-218165 discloses formation of a silica layer having an oxygen concentration of from 1% by weight to 10% by weight by heating a silicon carbide sintered body under an air atmosphere at from 800° C. to 1600° C. for from 5 hours to 100 hours.

Moreover, a urea-SCR (Selective Catalytic Reduction) device for converting NOx in exhaust gases has been proposed in recent years.

In the urea-SCR device, aqueous urea solution, for example, is sprayed into an exhaust gas purifying device equipped with a honeycomb catalyst body that is a honeycomb structure supporting a catalyst such as zeolite thereon. Then, zeolite adsorbs ammonia generated by pyrolysis of urea to reduce NOx.

The contents of JP-A 2003-154223 and JP-A 2000-218165 are incorporated herein by reference in their entirety.

### SUMMARY OF THE INVENTION

According to one aspect of the present invention, a honeycomb catalyst body includes a honeycomb structure and a catalyst. The honeycomb structure includes a porous honeycomb fired body having at least one cell wall defining a plurality of cells extending along a longitudinal direction of the porous honeycomb fired body. The plurality of cells is provided in parallel with one another. The honeycomb fired body contains silicon carbide particles and a silica layer formed on a surface of each of the silicon carbide particles. The silica layer has a thickness of from about 5 nm to about 100 nm measured by X-ray photoelectron spectroscopy. The catalyst contains at least one of oxide ceramics and zeolite. The catalyst is provided on a surface of the silica layer. An amount of at least one of the oxide ceramics and the zeolite is about 50 g/L or more.

According to another aspect of the present invention, a method for manufacturing a honeycomb catalyst body includes: oxidizing a honeycomb structure including a porous honeycomb fired body by heating under an oxidative atmosphere at from about 700° C. to about 1100° C. for from about 1 hour to about 10 hours, the honeycomb fired body having at least one cell wall defining a plurality of cells extending along a longitudinal direction of the porous honeycomb fired body, the plurality of cells being provided in parallel with one another, the oxidizing of the honeycomb structure including forming a silica layer on a surface of each of silicon carbide particles contained in the honeycomb fired body, the silica layer having a thickness measured by X-ray photoelectron spectroscopy of from about 5 nm to about 100 nm; and treating the oxidized honeycomb structure with a supporting process so that a catalyst containing at least one of oxide ceramics and zeolite is provided on the oxidized honeycomb structure, an amount of at least one of the oxide ceramics and the zeolite being about 50 g/L or more.

### BRIEF DESCRIPTION OF THE DRAWINGS

Amore complete appreciation of the invention and many of the attendant advantages thereof will be readily obtained as the same becomes better understood by reference to the following detailed description when considered in connection with the accompanying drawings.

FIG. 1 is a schematic perspective view illustrating one example of a honeycomb structure configuring a honeycomb catalyst body of a first embodiment of the present invention.

FIG. 2A is a schematic perspective view illustrating one example of a honeycomb fired body configuring the honeycomb structure illustrated in FIG. 1. FIG. 2B is an A-A line cross-sectional view illustrating the honeycomb fired body in FIG. 2A.

FIG. 3 is a partially enlarged view schematically illustrating one example of the honeycomb catalyst body of the first embodiment of the present invention.

FIG. 4 is a graph showing a relation between the thickness of a silica layer and NOx conversion efficiency in Examples and Comparative Examples.

FIG. 5A is a schematic perspective view illustrating one example of a honeycomb structure configuring a honeycomb catalyst body of a second embodiment of the present invention. FIG. 5B is a B-B line cross-sectional view of the honeycomb structure in FIG. 5A.

### DESCRIPTION OF THE EMBODIMENTS

A honeycomb catalyst body according to an embodiment of the present invention includes: a honeycomb structure including a porous honeycomb fired body having a large number of cells longitudinally placed in parallel with one another with a cell wall interposed therebetween, the honeycomb fired body being mainly made of silicon carbide particles; and a catalyst containing oxide ceramics or zeolite, the catalyst being supported on the honeycomb structure, wherein a silica layer is formed on a surface of each of the silicon carbide particles, the catalyst is supported on the surface of each of the silicon carbide particles via the silica layer therebetween, the silica layer has a thickness measured by X-ray photoelectron spectroscopy (XPS) of from about 5 nm to about 100 nm, and an amount of the oxide ceramics or the zeolite supported is about 50 g/L or more.

In the honeycomb catalyst body according to an embodiment of the present invention, a silica layer is formed on the surface of each of silicon carbide particles constituting the honeycomb structure. A catalyst containing oxide ceramics or zeolite is supported on the surface of each of the silicon carbide particles via the silica layer therebetween.

An oxide layer formed on the surface of each of the silicon carbide particles tends to allow the catalyst to be substantially uniformly supported.

In the honeycomb catalyst body according to an embodiment of the present invention, the thickness of the silica layer measured by X-ray photoelectron spectroscopy (XPS) is from about 5 nm to about 100 nm.

When the thickness of the silica layer measured by X-ray photoelectron spectroscopy (XPS) (hereinafter, simply referred to as “the thickness of the silica layer”) is from about 5 nm to about 100 nm, it is presumable that the catalyst containing oxide ceramics or zeolite is more likely to be substantially uniformly supported for the following reasons. There is a neck portion between the silicon carbide particles (a narrow part formed between two particles bound to each other). In the case that a silica layer having a thickness of from about 5 nm to about 100 nm is formed in such a neck portion, the neck portion is allowed to have no deep depression. In such a state, a catalyst is more easily supported on the surface of each of the silicon carbide particles. Accordingly, it may become easier to avoid a case where more catalyst is supported on the depression of the neck portion. As a result, the catalyst tends to be presumably supported on the surface of each of the silicon carbide particles in a substantial uniform thickness.

In the case that the silica layer has a thickness of less than about 5 nm, NOx conversion efficiency is less likely to be sufficient when such a honeycomb catalyst body is used in a urea-SCR device. The reason for this is presumably that the catalyst is less likely to be substantially uniformly supported on the surface of each of the silicon carbide particles because the catalyst is likely to pile up in the neck portion between the silicon carbide particles when the silica layer has a thickness of less than about 5 nm.

On the other hand, also in the case where the silica layer has a thickness of more than about 100 nm, NOx conversion efficiency is less likely to be sufficient when such a honeycomb catalyst body is used in a urea-SCR device. The reason for this is presumably that pores in the cell wall are likely to be buried when the silica layer has a thickness of more than about 100 nm. This is likely to cause nonuniform flow of gases through the cell wall of the honeycomb fired body to be likely to be lower NOx conversion efficiency.

In the honeycomb catalyst body according to an embodiment of the present invention, the amount of the oxide ceramics or the zeolite supported is about 50 g/L or more.

As above mentioned, in the honeycomb catalyst body according to an embodiment of the present invention, oxide ceramics or zeolite is supported substantially uniformly on the surface of each of the silicon carbide particles. However, in the case the amount of the oxide ceramics or the zeolite supported is less than about 50 g/L, NOx conversion efficiency is less likely to be sufficient when such a honeycomb catalyst body is used in a urea-SCR device. Or it may be needed to increase the size of the honeycomb catalyst body.

In the honeycomb catalyst body according to the embodiment of the present invention, the oxide ceramics or the zeolite is preferably supported on an inside of the cell wall of the honeycomb fired body.

The oxide ceramic or the zeolite supported on the inside of the cell wall of the honeycomb fired body is likely to prevent a case where a large amount of the catalyst is supported on the cell wall. This is likely to prevent increase in the pressure loss of the honeycomb catalyst body. In addition, since an enough contact distance is likely to be kept between exhaust gases and the catalyst such as zeolite relative to the flow rate of the exhaust gases passing through the cell walls, the catalyst such as zeolite is likely to exert its catalytic function.

In the honeycomb catalyst body according to the embodiment of the present invention, the honeycomb structure may have a single honeycomb fired body. Further, in the honeycomb catalyst body according to the embodiment of the present invention, the honeycomb structure may have a plurality of honeycomb fired bodies bound to one another with an adhesive layer interposed therebetween.

A method for manufacturing a honeycomb catalyst body according to the embodiment of the present invention is a method for manufacturing a honeycomb catalyst body including: a honeycomb structure including a porous honeycomb fired body having a large number of cells longitudinally placed in parallel with one another with a cell wall interposed therebetween, the honeycomb fired body being mainly made of silicon carbide particles; and a catalyst containing oxide ceramics or zeolite, the catalyst being supported on the honeycomb structure, the method including: oxidizing the honeycomb structure including a porous honeycomb fired body by heating under an oxidative atmosphere at from about 700° C. to about 1100° C. for from about 1 hour to about 10 hours; and supporting a catalyst containing oxide ceramics or zeolite on the honeycomb structure after the oxidation process, wherein the oxidation process includes formation of a silica layer having a thickness measured by X-ray photoelectron spectroscopy (XPS) of from about 5 nm to about 100 nm on a surface of each of the silicon carbide particles in the honeycomb fired body, and the supporting process includes supporting of about 50 g/L or more of the oxide ceramics or the zeolite.

In the method for manufacturing a honeycomb catalyst body according to the embodiment of the present invention, the honeycomb catalyst body of an embodiment of the present invention is favorably manufactured.

In the method for manufacturing a honeycomb catalyst body according to the embodiment of the present invention, the oxidative atmosphere in the oxidation process preferably has an oxygen concentration of from about 5% by volume to about 21% by volume.

In the case where the oxygen concentration of the oxidative atmosphere is not less than about 5% by volume, oxidation of the surface of each of the silicon carbide particles is less likely to be unstable and formation of a silica layer having a desired thickness is less likely to be difficult. Further, in the case where the oxygen concentration of the oxidative atmosphere is not less than about 5% by volume, a heat treatment is not required to be performed for a long period of time and the manufacturing efficiency is less likely to be lowered. On the other hand, in the case where the oxygen concentration of the oxidative atmosphere is not more than about 21% by volume, an additional process is not needed for generating the oxidative atmosphere, such as preparation of gaseous oxygen, and the manufacturing efficiency is less likely to be lowered.

In the method for manufacturing a honeycomb catalyst body according to the embodiment of the present invention, the method preferably further includes bonding a plurality of honeycomb fired bodies via an adhesive layer therebetween.

For converting NOx at a high efficiency in a urea-SCR device, it is presumably required to support a large amount of zeolite on cell walls of a honeycomb structure. This is for adsorption of a large amount of ammonia and gases are preferably diffused in the cell walls.

Assuming use of a honeycomb catalyst body in a urea-SCR device, present inventors have tried to develop a honeycomb catalyst body in which a catalyst is supported on a honeycomb structure (cell wall) when a large amount of catalyst is supported on the honeycomb structure.

The present inventors have first manufactured a conventional honeycomb catalyst body based on JP-A 2003-154223 and JP-A 2000-218165.

However, the honeycomb catalyst body manufactured in the above method did not show sufficient NOx conversion efficiency when used in a urea-SCR device. Such a result is presumably caused by zeolite nonuniformly supported in the honeycomb catalyst body.

Namely, as above described, it is considered that a too-thin silica layer causes piling up of zeolite (catalyst) in an interglanular neck portion of the silicon carbide particles, resulting in nonuniform support of zeolite (catalyst).

As disclosed in JP-A2000-218165, it is considered that even in the case that a silica layer having an oxygen concentration (content as oxygen) of from 1% by weight to 10% by weight is formed on the surface of each of the silicon carbide particles, a too-thick silica layer causes nonuniform support of zeolite (catalyst).

From these studies, the present inventors have found out that control of the thickness of the silica layer to be formed on the surface of the silicon carbide particles within a predetermined range allows a catalyst to be more uniformly supported on the surface of each of the silicon carbide particles, even in the case that a large amount of catalyst is supported on the honeycomb structure. Accordingly, the embodiment of the present invention has been completed.

In an embodiment of the present invention, it is allowed to provide a honeycomb catalyst body in which a catalyst is supported on the surface of silicon carbide particles that form the honeycomb structure and each have a silica layer formed on the surface.

In an embodiment of the present invention, it is also allowed to provide a method for manufacturing the honeycomb catalyst body.

Hereinafter, specific description is given on embodiments of the present invention. However, the present invention is not limited to these embodiments and these embodiments may be changed without departing from the present invention.

The embodiments will now be described with reference to the accompanying drawings, wherein like reference numerals designate corresponding or identical elements throughout the various drawings.

### First Embodiment

Now, a description is given with reference to drawings on a first embodiment that is one embodiment of a honeycomb catalyst body and a method for manufacturing a honeycomb catalyst body of the present invention.

First, a description is given on a honeycomb catalyst body according to the first embodiment of the present invention.

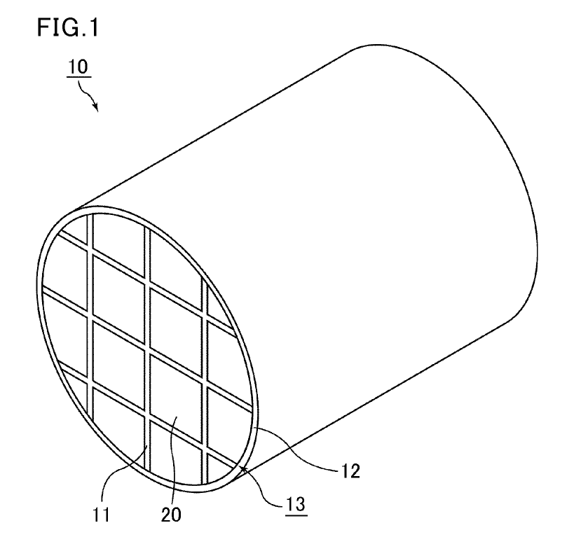

FIG. 1 is a schematic perspective view illustrating one example of a honeycomb structure configuring a honeycomb catalyst body of the first embodiment of the present invention.

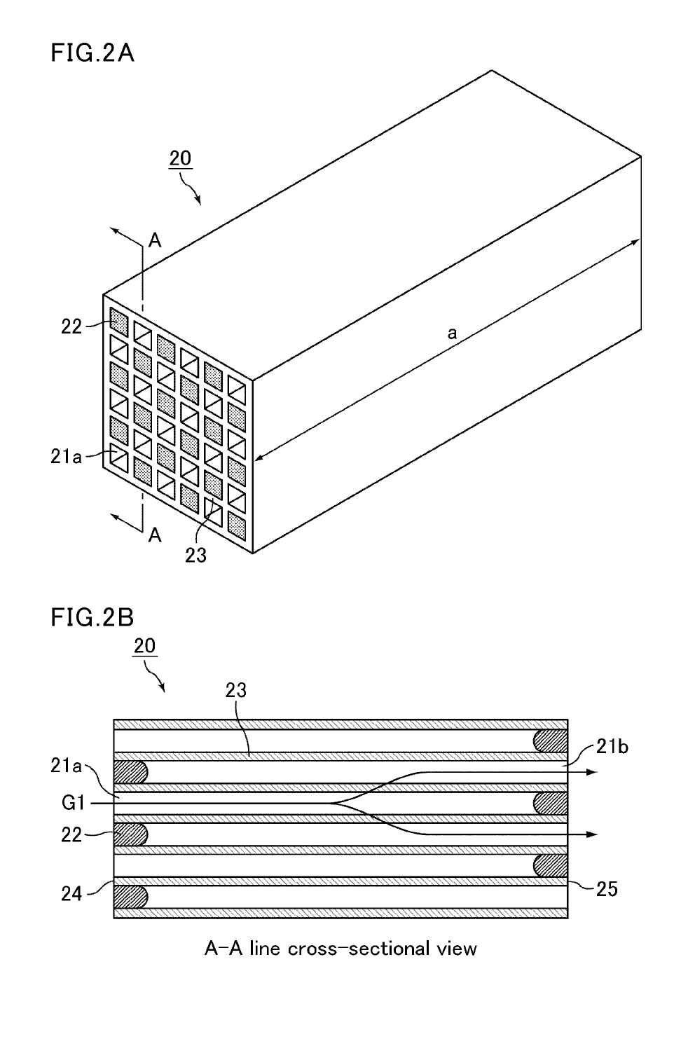

FIG. 2A is a schematic perspective view illustrating one example of a honeycomb fired body configuring the honeycomb structure illustrated in FIG. 1. FIG. 2B is an A-A line cross-sectional view illustrating the honeycomb fired body in FIG. 2A.

In a honeycomb structure 10 illustrated in FIG. 1, a plurality of porous honeycomb fired bodies 20 mainly made of silicon carbide particles are bound to one another via an adhesive layer 11 therebetween to form a ceramic block 13. On the periphery of the ceramic block 13, a coat layer 12 is formed to prevent exhaust gas leakage. Here, the coat layer may be formed according to need.

Such a honeycomb structure including a plurality of honeycomb fired bodies bound to one another is referred to as an aggregated honeycomb structure.

The honeycomb fired bodies 20 each have a shape illustrated in FIGS. 2A and 2B.

In each of the honeycomb fired bodies 20 illustrated in FIGS. 2A and 2B, a large number of cells 21a and 21b are longitudinally (direction of arrow “a” in FIG. 2A) placed in parallel with one another with a cell wall 23 interposed therebetween. Either one end portion of each of the cells 21a and 21b is plugged with a plug material 22. Therefore, exhaust gases G1 (in FIG. 2B, exhaust gases are represented by “G1” and a flow thereof is indicated by arrows) which have flowed into one of the cells 21a with an opening on one end face 24 surely pass through the cell wall 23 that partitions the cells 21a and the cells 21b with an opening on the other end face 25, and flow out from one of the cells 21b. Thus, the cell wall 23 functions as a filter for capturing PM and the like.

Here, among the surfaces of the honeycomb fired body and honeycomb structure, the surfaces to which the cells are open are termed “end faces” and the surfaces other than the ends faces are termed “side faces”.

The honeycomb fired body is mainly made of silicon carbide particles and may be referred to as a silicon carbide honeycomb fired body. Specifically, the honeycomb fired body contains about 60% by weight or more of silicon carbide. In the honeycomb fired body, a large number of silicon carbide particles serving as aggregates are bound to one another with a large number of fine pores kept therebetween.

The honeycomb fired body may contain other components, provided that about 60% by weight or more of silicon carbide is contained. For example, the honeycomb fired body may contain about 40% by weight or less of silicon. The main component of the materials for forming the honeycomb fired body may be silicon-containing silicon carbide that is silicon carbide blended with metal silicon or may be silicon carbide bound with silicon or a silicate compound. In the case that the honeycomb fired body contains silicon such as metal silicon, a silica layer is also formed on the surface of the silicon.

In particular, the honeycomb fired body preferably contains about 98% by weight or more of silicon carbide or about 98% by weight or more of a combination of silicon carbide and metal silicon.

In the honeycomb catalyst body of the present embodiment, a catalyst containing oxide ceramics or zeolite is supported on the surface of the silicon carbide honeycomb fired body configuring the honeycomb structure. The catalyst is preferably supported on cell walls in the honeycomb fired body configuring the honeycomb structure.

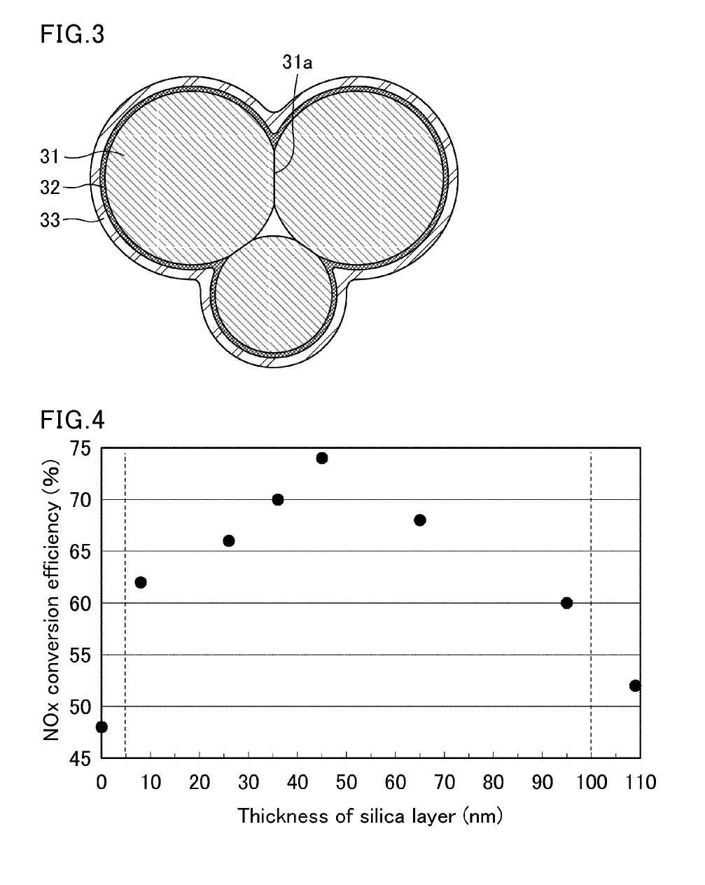

FIG. 3 is a partially enlarged view schematically illustrating one example of the honeycomb catalyst body of the first embodiment of the present invention.

As illustrated in FIG. 3, silicon carbide particles 31 forming the honeycomb fired body are bound to one another via a neck 31a therebetween. On each of the surfaces of the silicon carbide particles 31, a silica (SiO₂) layer 32 is formed. A catalyst 33 is supported on the surfaces of the silicon carbide particles 31 via the silica layers 32 therebetween.

The thickness of the silica layer measured by X-ray photoelectron spectroscopy (XPS) is from about 5 nm to about 100 nm. In the honeycomb catalyst body according to embodiments of the present invention, the thickness of the silica layer may be measured by X-ray photoelectron spectroscopy (XPS). The X-ray photoelectron spectroscopy (XPS) is an analysis method in which photoelectron energy generated by irradiation of a sample surface with X rays is measured by using a device named energy analyzer. The X-ray photoelectron spectroscopy (XPS) enables analysis of the constituent elements of the sample and its electronic state. In addition, alternate performance of the X-ray photoelectron spectroscopy (XPS) and ion sputtering clarifies change in composition in the depth direction (thickness direction) of the sample.

In the honeycomb catalyst body according to embodiments of the present invention, the depth (thickness) of the silica layer can be determined by filing the sample surface at a constant rate by the ion sputtering and analyzing the composition thereof by the X-ray photoelectron spectroscopy (XPS). Based on the measurement results using these measuring methods, it is determined that the silica layer having a thickness of from about 5 nm to about 100 nm is formed on each of the surfaces of the silicon carbide particles.

The lower limit of the thickness of the silica layer is more preferably about 20 nm, and still more preferably about 30 nm. The upper limit of the thickness of the silica layer is more preferably about 70 nm, and still more preferably about 60 nm.

With regard to the silica layer formed on each of the surfaces of the silicon carbide particles, the thickness is more preferably from about 8 nm to about 95 nm.

In the present description, the thickness of the silica layer refers to the thickness of the silica layer prior to the use of the honeycomb catalyst body mounted on an automobile and the like.

In the honeycomb catalyst body according to embodiments of the present invention, the weight ratio of the silica layer corresponds to the weight increase obtainable by measuring the weight of the honeycomb fired body or the honeycomb structure before and after formation of the silica layer.

The weight increase is preferably from about 0.06% by weight to about 0.49% by weight. In such a case, the silica layer is allowed to have a substantially uniform thickness.

Next, a description is given on the catalyst. The main component of the catalyst is oxide ceramics or zeolite. The catalyst may further contain other components such as noble metal components or alkaline earth metals, in addition to the oxide ceramics or zeolite.

Commonly, it is possible to categorize zeolite as one kind of oxide ceramics. However, in the present description, zeolite is not considered as oxide ceramics. In addition, zeolite includes not only zeolite as aluminosilicates but also zeolite analogs such as aluminophosphate and aluminogermanate.

Examples of oxide ceramics include ceramics such as Al₂O₃, ZrO₂, TiO₂, and CeO₂. Each of these may be used alone, or two or more of these may be used in combination.

Among the above ceramics, ceramics containing Al₂O₃ and CeO₂ is preferable.

Examples of zeolite include β-type zeolite, Y-type zeolite, ferrierite, ZSM-5 type zeolite, mordenite, faujasite, A-type zeolite, L-type zeolite, SAPO (Silicoaluminophosphate), MeAPO (Metalaluminophosphate), and the like. Each of these may be used alone, or two or more of these may be used in combination.

Among the above zeolites, β-type zeolite, ZSM-5 type zeolite, or SAPO is preferable. Moreover, Among the SAPOs, SAPO-5, SAPO-11, or SAPO-34 is preferable, and SAPO-34 is more preferable. Among the MeAPOs, MeAPO-34 is preferable.

The zeolite is preferably ion exchanged with metal ions.

Examples of the metal ions include copper ion, iron ion, nickel ion, zinc ion, manganese ion, cobalt ion, silver ion, vanadium ion, and the like. Each of these may be used alone, or two or more of these may be used in combination.

Among the above metal ions, copper ion or iron ion is preferable from the standpoint of NOx conversion efficiency.

The amount of oxide ceramics or zeolite supported on the honeycomb structure is about 50 g/L or more, and is preferably from about 50 g/L to about 150 g/L. More preferably, the amount of oxide ceramics or zeolite supported on the honeycomb structure is about 80 g/L or more, and is still more preferably from about 80 g/L to about 150 g/L.

When the amount of oxide ceramics or zeolite is about 50 g/L or more, the amount of the catalyst is less likely to be small and NOx conversion efficiency is likely to be sufficient when such a honeycomb catalyst body is used in a urea-SCR device. Further, it may not be needed to increase the size of the honeycomb catalyst body. When the amount of oxide ceramics or zeolite is about 150 g/L or less, the amount of the catalyst is not too large and the pore size (pore diameter) in the honeycomb fired body is less likely to be reduced, thereby the pressure loss of the honeycomb structure is less likely to be increased.

In the present description, the amount of the oxide ceramics or zeolite supported on the honeycomb structure refers to the weight of the oxide ceramics or zeolite per litter of apparent volume of the honeycomb structure.

Here, the apparent volume of the honeycomb structure includes the volume of the adhesive layer and/or the coat layer.

The oxide ceramics or the zeolite is preferably supported on the inside of the cell walls in the honeycomb fired body.

The oxide ceramics or zeolite supported on the inside of the cell walls is likely to prevent a case that a large amount of catalyst is supported on the cell walls, thereby increase in the pressure loss of the honeycomb catalyst body is likely to be avoided. Additionally, since the contact distance between the catalyst such as zeolite and exhaust gases is likely to be kept enough relative to the flow rate of the exhaust gases passing through the cell walls, the catalyst such as zeolite is likely to exert its catalytic function.

In the honeycomb catalyst body of the present embodiment, the average particle size of the catalyst (oxide ceramics or zeolite) is not particularly limited, and is preferably from about 0.5 μm to about 5 μm.

In the case that the average particle size of the catalyst is about 0.5 μm or more, the catalyst is less likely to pile up in the interglanular neck of the silicon carbide particles to be less likely to deteriorate the conversion performance. On the other hand, when the average particle size of the catalyst is about 5 μm or less, a contact between exhaust gases and the catalyst or dispersion of the catalyst is less likely to be poor.

Next, a description is given on a method for manufacturing the honeycomb catalyst body according to the first embodiment of the present invention.

A method for manufacturing a honeycomb catalyst body according to the present embodiment is a method for manufacturing a honeycomb catalyst body including: a honeycomb structure including a porous honeycomb fired body having a large number of cells longitudinally placed in parallel with one another with a cell wall interposed therebetween, the honeycomb fired body being mainly made of silicon carbide particles; and a catalyst containing oxide ceramics or zeolite, the catalyst being supported on the honeycomb structure, the method including: oxidizing the honeycomb structure including a porous honeycomb fired body by heating under an oxidative atmosphere at from about 700° C. to about 1100° C. for from about 1 hour to about 10 hours; and supporting a catalyst containing oxide ceramics or zeolite on the honeycomb structure after the oxidation process, wherein the oxidation process includes formation of a silica layer having a thickness measured by X-ray photoelectron spectroscopy (XPS) of from about 5 nm to about 100 nm on a surface of each of the silicon carbide particles in the honeycomb fired body, and the supporting process includes supporting of about 50 g/L or more of the oxide ceramics or the zeolite.

The honeycomb structure used in the method for manufacturing the honeycomb catalyst body of the present embodiment may be manufactured through the following procedures: molding a ceramic raw material to forma honeycomb molded body having a large number of cells longitudinally placed in parallel with one another with a cell wall interposed therebetween; firing the honeycomb molded body to manufacture a honeycomb fired body; and bonding a plurality of the honeycomb fired bodies with an adhesive layer interposed therebetween to manufacture a ceramic block.

Hereinafter, a description is given on the method for manufacturing the honeycomb catalyst body in which a catalyst is supported on a honeycomb structure having a honeycomb fired body as illustrated in FIGS. 2A and 2B in the order of procedures.

First, a molding process is carried out in which a ceramic raw material is molded to give a honeycomb molded body having a large number of cells longitudinally placed in parallel with one another with a cell wall interposed therebetween.

More specifically, silicon carbide powders having different average particle sizes as ceramic powder, an organic binder, a fluid plasticizer, a lubricant, and water are first mixed to give a ceramic raw material (wet mixture) for manufacturing a honeycomb molded body.

Next, the wet mixture is charged into an extrusion molding machine. By extrusion-molding the wet mixture, a honeycomb fired body in a desired shape is manufactured.

Subsequently, the honeycomb molded body is cut at a desired length and dried using a microwave drying apparatus, a hot-air drying apparatus, a dielectric drying apparatus, a reduced-pressure drying apparatus, a vacuum drying apparatus, a freeze drying apparatus, and the like. Then, a plugging process is carried out in which predetermined end portions of the cells are filled with a plug material paste serving as plugs to plug the cells.

The ceramic raw material (wet mixture) can be used as a plug material paste.

Then, a degreasing process is carried out in which an organic matter in the honeycomb molded body is heated in a degreasing furnace. Then, the degreased honeycomb molded body is transferred to a firing furnace and a firing process is carried out. In this manner, a honeycomb fired body as illustrated in FIGS. 2A and 2B is manufactured.

Here, the plug material paste filled in the predetermined end portions of the cells is fired by heating to be plugs.

Conditions conventionally used in manufacturing honeycomb fired bodies can be applied to conditions for the above cutting, drying, plugging, degreasing, and firing processes.

Next, a bonding process is carried out in which a plurality of the honeycomb fired bodies are bonded to each other with an adhesive layer interposed therebetween to provide a ceramic block. Hereinafter, an exemplary bonding process is described.

First, an adhesive paste is applied to the predetermined side faces of each honeycomb fired body to form an adhesive paste layer. On the adhesive paste layer, another honeycomb fired body is stacked, and this procedure is repeated. In this manner, an aggregate of the honeycomb fired bodies is manufactured which includes the honeycomb fired bodies with an adhesive paste applied on the side faces.

Subsequently, the aggregate of the honeycomb fired bodies is heated by using a drying apparatus or the like so that the adhesive paste is dried and solidified. In this manner, a ceramic block in which a plurality of honeycomb fired bodies are bonded to one another by interposing an adhesive layer is manufactured.

The adhesive paste used may contain an inorganic binder, an organic binder, and inorganic particles. The adhesive paste may further contain inorganic fiber and/or whisker.

Then, a periphery cutting process is carried out in which the ceramic block is subjected to a cutting process.

Specifically, cutting process is performed on the ceramic block by using a diamond cutter to manufacture a ceramic block having the periphery processed into a substantially round pillar shape.

A coat layer forming process is carried out in which a coat material paste is applied around the periphery of the substantially round pillar-shaped ceramic block, dried, and solidified to form a coat layer.

As the coat material paste, the adhesive paste may be used.

In this manner, a honeycomb structure is manufactured.

An oxidation process is carried out in which the honeycomb structure is oxidized by heating under an oxidative atmosphere at from about 700° C. to about 1100° C. for from about 1 hour to about 10 hours.

The oxidation process is carried out under an atmosphere containing oxygen and preferably carried out under an ambient atmosphere from the standpoint of cost efficiency.

The oxygen concentration (content as oxygen) of the oxidative atmosphere is not particularly limited, and is preferably from about 5% by volume to about 21% by volume. From the standpoint of cost efficiency, air is preferably used. When the oxygen concentration of the oxidative atmosphere is about 5% by volume or more, oxidation of the surface of each of the silicon carbide particles of the honeycomb fired body is less likely to be unstable and formation of a silica layer having a desired thickness is less likely to be difficult. Further, in the case where the oxygen concentration of the oxidative atmosphere is about 5% by volume or more, the heat treatment is not required to be performed for a long period of time and the manufacturing efficiency is less likely to be lowered. On the other hand, in the case where the oxygen concentration of the oxidative atmosphere is about 21% by volume or less, an additional process is not needed for generating the oxidative atmosphere, such as preparation of gaseous oxygen, and the manufacturing efficiency is less likely to be lowered.

The heat treatment temperature in the oxidation process is preferably from about 700° C. to about 1100° C.

When the heat treatment temperature is less than about 700° C., formation of a silica layer having a desired thickness is difficult and the heat treatment is required to be performed for a long period of time to forma silica layer having a target thickness. On the other hand, when the heat treatment temperature is more than about 1100° C., it is difficult to control the heat treatment temperature.

The heat treatment time in the oxidation process is from about 1 hour to about 10 hours, and is appropriately determined in accordance with the heat treatment temperature and the target thickness of the silica layer.

Specifically, when the heat treatment temperature is about 700° C. or more and is less than about 850° C., the heat treatment time is preferably from about 3hours to about 12 hours. When the heat treatment temperature is about 850° C. or more and is less than about 950° C., the heat treatment time is preferably from about 2 hours to about 10 hours. When the heat treatment temperature is about 950° C. or more and is less than about 1100° C., the heat treatment time is preferably from about 0.5 hour to about 4.5 hours. In particular, the oxidation process at from about 1000° C. to about 1100° C. for from about 1 hour to about 4 hours is preferable.

When the heat treatment time is shorter than the lower limit, it is difficult to form a silica layer having a target thickness. On the other hand, when the heat treatment time is longer than the upper limit, a formed silica layer may be thicker than the target thickness. As a result, it may be difficult to substantially uniformly support a catalyst on the honeycomb structure in a supporting process described later.

In the present description, the heat treatment time refers to a time period during which the temperature is maintained at the target heat treatment temperature after being raised to that temperature. Accordingly, the time for heating the honeycomb structure during the entire oxidation process includes a time required for temperature rise and temperature fall in addition to the heat treatment time.

Through the oxidation process carried out under the above conditions, a silica layer having a thickness measured by X-ray photoelectron spectroscopy (XPS) of from about 5 nm to about 100 nm is formed on the surface of each of the silicon carbide particles contained in the honeycomb fired body configuring the honeycomb structure.

After the oxidation process, a supporting process is carried out in which a catalyst containing oxide ceramics or zeolite is supported on the honeycomb structure.

The catalyst to be supported on the honeycomb structure may be the catalyst mentioned in the description on the honeycomb catalyst body of the present embodiment.

A method of supporting the catalyst on the honeycomb structure may be a method in which the honeycomb structure is first immersed in a slurry containing oxide ceramics or zeolite, next removed from the slurry, and then heated.

In the supporting process, the amount of the oxide ceramics or zeolite supported is about 50 g/L or more, and is preferably from about 50 g/L to about 150 g/L. More preferably, the amount of the oxide ceramics or zeolite supported is about 80 g/L or more, and is still more preferably from about 80 g/L to about 150 g/L.

The amount of the oxide ceramics or zeolite supported may be adjusted by a method of repeating the processes of immersing the honeycomb structure in the slurry and heating the honeycomb structure, a method of changing the concentration of the slurry, or the like.

In this manner, the honeycomb catalyst body according to the first embodiment of the present invention is manufactured.

In the above method for manufacturing the honeycomb catalyst body, an oxidation process is carried out after the coat layer forming process. However, an oxidation process may be carried out between the bonding process and the periphery cutting process or between the periphery cutting process and the coat layer forming process in the method for manufacturing the honeycomb catalyst body of the present embodiment.

The honeycomb structure subjected to the oxidation process is not limited to the honeycomb structure manufactured in the above processes, but may be any aggregated honeycomb structure. For example, the oxidation process may be carried out to a honeycomb structure in which no coat layer is formed.

Hereinafter, effects of the honeycomb catalyst body and a method for manufacturing the honeycomb catalyst body of the present embodiment are described.

(1) In the honeycomb catalyst body and a method for manufacturing the honeycomb catalyst body of the present embodiment, a silica layer is formed on the surface of each of the silicon carbide particles in the honeycomb fired body configuring the honeycomb structure. A catalyst containing oxide ceramics or zeolite is supported on the surface of each of the silicon carbide particles via the silica layer therebetween.

An oxide layer formed on the surface of each of the silicon carbide particles allows the catalyst to be likely to be substantially uniformly supported.

(2) In the honeycomb catalyst body and a method for manufacturing the honeycomb catalyst body of the present embodiment, the thickness of the silica layer measured by X-ray photoelectron spectroscopy (XPS) is from about 5 nm to about 100 nm.

The thickness of the silica layer measured by X-ray photoelectron spectroscopy (XPS) in a range of from about 5 nm to about 100 nm is likely to facilitate substantially uniform supporting of the catalyst containing oxide ceramics or zeolite on the surface of each of the silicon carbide particles.

(3) In the honeycomb catalyst body and a method for manufacturing the honeycomb catalyst body of the present embodiment, the amount of the oxide ceramics or zeolite supported is about 50 g/L or more.

In the honeycomb catalyst body of the present embodiment, the ceramic oxide or zeolite is substantially uniformly supported on the surface of each of the silicon carbide particles in the honeycomb fired body. Since the amount of the oxide ceramics or zeolite supported is about 50 g/L or more, enough NOx conversion efficiency is likely to be achieved when such a honeycomb catalyst body is used in a urea-SCR device.

### EXAMPLES

The following illustrates examples that more specifically disclose the first embodiment of the present invention, and the present invention is not limited to these examples.

### Example 1

### (Manufacture of Honeycomb Catalyst Body)

(1) Manufacturing Process of Honeycomb Structure

An amount of 52.8% by weight of a silicon carbide coarse powder having an average particle size of 22 μm and 22.6% by weight of a silicon carbide fine powder having an average particle size of 0.5 μm were mixed. To the resulting mixture, 2.1% by weight of an acrylic resin, 4.6% by weight of an organic binder (methylcellulose), 2.8% by weight of a lubricant (UNILUB, manufactured by NOF Corporation), 1.3% by weight of glycerin, and 13.8% by weight of water were added, and then kneaded to prepare a wet mixture. The obtained wet mixture was extrusion-molded, and an extrusion-molded body was cut to manufacture a raw honeycomb molded body having the same shape as that illustrated in FIGS. 2A and 2B and having cells not plugged.

This raw honeycomb molded body was dried by using a microwave drying apparatus to manufacture a dried honeycomb molded body. Then, predetermined cells of the dried honeycomb molded body were filled with a plug material paste having the same composition as the above-mentioned wet mixture, and the honeycomb molded body was dried again by using the drying apparatus.

The dried honeycomb molded body was degreased at 400° C., and then fired at 2200° C. in a normal-pressure argon atmosphere for 3 hours so that a honeycomb fired body made of a silicon carbide sintered body was manufactured. The honeycomb fired body had a porosity of 45%, an average pore diameter of 15 μm, measurements of 34.3 mm×34.3 mm×150 mm, the number of cells (cell density) of 46.5 pcs/cm² and a thickness of each cell wall of 0.25 mm (10 mil).

Next an adhesive paste was prepared which contains alumina fibers having an average fiber length of 20 μm and an average fiber size of 2 μm (30% by weight), silicon carbide particles having an average particle size of 0.6 μm (21% by weight), silica sol (15% by weight, solids content: 30% by weight), carboxymethyl cellulose (5.6% by weight), and water (28.4% by weight).

A number of 16 pieces of honeycomb fired bodies were used to manufacture an aggregate of the honeycomb fired bodies by applying the adhesive paste on the side faces of the honeycomb fired bodies and the honeycomb fired bodies were bonded to one another (4 pieces×4 pieces) with the adhesive paste interposed therebetween.

Further, the aggregate of the honeycomb fired bodies was heated at 120° C. so that the adhesive paste was dried and solidified. In this manner, a rectangular pillar-shaped ceramic block was manufactured in which an adhesive layer having a thickness of 1.0 mm was formed.

Subsequently, the periphery of the ceramic block was cut with a diamond cutter, whereby a round pillar-shaped ceramic block having a diameter of 142 mm was manufactured.

Next, a coat material paste was applied around the periphery of the round pillar-shaped ceramic block to form a coat material paste layer. Then, the coat material paste layer was dried and solidified at 120° C. to form a coat layer, whereby a round pillar-shaped honeycomb structure having a coat layer around the periphery and measurements of 143.8 mm in diameter×150 mm in length was manufactured.

The adhesive paste was used as a coat material paste.

(2) Oxidation Process

The manufactured honeycomb structure was heated under an ambient atmosphere. The temperature was raised from room temperature to 700° C. at a rate of 300° C./hour. The honeycomb structure was allowed to stand at 700° C. for three hours. Then the temperature was lowered to 300° C. at a rate of 100° C./hour over four hours. Then, the honeycomb structure was placed at room temperature (25° C.)

In the oxidation process, the surface of the honeycomb fired body configuring the honeycomb structure is oxidized. More specifically, a silica layer is formed on the surface of each of the silicon carbide particles in the honeycomb fired body.

(3) Supporting Process

The following zeolite as a catalyst was supported on the cell walls in the honeycomb structure after the oxidation process. First, copper ion-exchanged zeolite powder (average particle size of 2 μm) was mixed with a sufficient amount of water and the mixture was stirred to prepare a zeolite slurry. The honeycomb structure was immersed in this zeolite slurry with one end face down and held for a minute. Then, the resulting honeycomb structure was heated at 110° C. for one hour to be dried and fired at 700° C. for one hour. In this manner, a zeolite supporting layer was formed.

At this time, the processes of immersion into the zeolite slurry and drying are repeated until the amount of the formed zeolite supporting layer reached 100 g per liter of apparent volume of the honeycomb structure.

In this manner, a honeycomb catalyst body having 100 g/L of zeolite supported thereon was manufactured.

### Examples 2 to 6

Honeycomb catalyst bodies were manufactured in the same manner as in Example 1, except that the heat treatment temperature and the heat treatment time in the oxidation process were changed as shown in Table 1.

The heat treatment temperature and the heat treatment time in Examples 2 to 6 were 900° C. for 10 hours, 1000° C. for 3 hours, 1100° C. for 1 hour, 1100° C. for 3 hours, and 1100° C. for 4 hours, respectively.

### Comparative Example 1

A honeycomb catalyst body was manufactured in the same manner as in Example 1, except that the oxidation process was not carried out.

### Comparative Example 2

A honeycomb catalyst body was manufactured in the same manner as in Example 1, except that the heat treatment temperature and the heat treatment time in the oxidation process were changed to 1100° C. for 5 hours.

(Evaluation of Honeycomb Catalyst Bodies)

(1) Determination of Weight Increase

The weight increase of the honeycomb fired body configuring the honeycomb catalyst body was determined with respect to each of the honeycomb catalyst bodies manufactured in Examples 1 to 6 and Comparative Examples 1 and 2.

In determination of the weight increase, one honeycomb fired body (34.3 mm×34.3 mm×150 mm) was cut out by using a diamond cutter from each of the honeycomb catalyst bodies manufactured in Examples 1 to 6 and Comparative Examples 1 and 2. The weight “M₁” of each oxidized honeycomb fired body was measured. Separately, the weight “M₀” of each honeycomb fired bodies manufactured in Examples 1 to 6 and Comparative Examples 1 and 2 prior to the oxidation process (prior to manufacture of an aggregate of the honeycomb fired bodies) was measured. Based on the measurement results, the weight increase was calculated by using the following formula.

Weight increase (% by weight)=[(M₁−M₀)/M₀]×100

Table 1 shows measurement results of the weight increase.

The weight increase was 0.06% by weight in Example 1, 0.20% by weight in Example 2, 0.25% by weight in Example 3, 0.30% by weight in Example 4, 0.33% by weight in Example 5, and 0.49% by weight in Example 6; and 0% by weight in Comparative Example 1, and 0.56% by weight in Comparative Example 2.

(2) Measurement of Thickness of Silica Layer by X-Ray Photoelectron Spectroscopy (XPS)

With respect to the honeycomb catalyst bodies manufactured in Examples 1 to 6 and Comparative Examples 1 and 2, the thickness of silica layers in honeycomb fired bodies was measured by X-ray photoelectron spectroscopy (XPS).

Samples for XPS measurement (2 cm×2 cm×0.25 mm) was cut out from silicon carbide parts of the honeycomb catalyst bodies manufactured in Examples 1 to 6 and Comparative Examples 1 and 2. The surface other than the cut-out face of each sample for XPS measurement was observed.

The XPS device used was Quantera SXM (trade name) manufactured by ULVAC-PHI, INC. and the X ray source was Al—Kα rays (Monochromated Al—Kα). The measurement conditions were a voltage of 15 kV, an output of 25 W, and a measurement area of 100 μmφ. Ion-sputtering conditions were an ion species of Ar⁺, a voltage of 1 kV (Examples 1 to 4 and Comparative Examples 1) or 2 kV (Examples 5 and 6 and Comparative Example 2), a sputtering rate (SiO₂ equivalent) of 1.5 nm/min (Examples 1 to 4 and Comparative Examples 1) or 5.4 nm/min (Examples 5 and 6 and Comparative Example 2).

Qualitative analysis (wide scanning) of each sample for XPS measurement and depth profile analysis with respect to C, O, and Si were conducted by using the XPS device. Based on the result of the depth profile analysis, the thickness of the silica layer was calculated using the time at the middle strength between the maximum strength and the minimum strength of the SiO₂ profile and the sputtering rate (SiO₂ equivalent) of each sample for XPS measurement.

Table 1 shows the thickness of the silica layers measured by X-ray photoelectron spectroscopy (XPS).

The thickness of the silica layer was 8 nm in Example 1, 26 nm in Example 2, 36 nm in Example 3, 45 nm in Example 4, 65 nm in Example 5, and 95 nm in Example 6; and less than 4 nm in Comparative Example 1 and 109 nm in Comparative Example 2.

(3) Measurement of NOx Conversion Efficiency

The NOx conversion efficiency was measured with respect to each of the honeycomb catalyst bodies manufactured in Examples 1 to 6 and Comparative Examples 1 and 2.

In measurement of the NOx conversion efficiency, one honeycomb fired body (34.3 mm×34.3 mm×150 mm) was cut out by using a diamond cutter from each of the honeycomb catalyst bodies manufactured in Examples 1 to 6 and Comparative Examples 1 and 2. The cut-out honeycomb fired body was further cut into a round pillar-shaped short body (φ1 inch (25.4 mm)×3 inches (76.2 mm)).

Next, each cell of the manufactured short bodies was filled with an adhesive paste so that either one end portion of the cell was plugged in the same manner as in the plugging and degreasing processes described above. The short bodies in which cells were plugged were degreased at 400° C. to give samples for measuring the NOx conversion efficiency.

The NOx conversion efficiency was measured by using a NOx conversion efficiency measuring device (Catalyst Test System: SIGU-2000, manufactured by HORIBA, Ltd.).

The NOx conversion efficiency measuring device has a gas generator and a reactor. The simulated exhaust gas and ammonia generated by the gas generator were passed through the reactor in which the sample for measuring the NOx conversion efficiency was set. The content (volume ratio) of the simulated exhaust gas was NO₂:350 ppm (NO₂/NOx=0.25), O₂:14%, H₂O:10%, and N₂:balance, and NH₃/NOx=1.

The flow rate was adjusted by using a flow controller to achieve the above content.

The reactor had a constant temperature of 200° C. Zeolite was made in contact with the simulated exhaust gas and ammonia under the condition of a space velocity (SV) of 7000 hr⁻¹.

NOx concentration “N₀” before the simulated exhaust gas passed through the sample for measuring the NOx conversion efficiency and NOx concentration “N₁” after the simulated exhaust gas passed through the sample for measuring the NOx conversion efficiency were measured. Based on the measurement results, the NOx conversion efficiency of each honeycomb catalyst body was determined using the following formula.

NOx conversion efficiency (%)=[(N₀−N₁)/N₀]×100

Table 1 shows the measurement results of the NOx conversion efficiency.

The NOx conversion efficiency was 62% in Example 1, 66% in Example 2, 70% in Example 3, 74% in Example 4, 68% in Example 5, and 60% in Example 6; and 48% in Comparative Example 1 and 52% in Comparative Example 2.

Table 1 shows the heat treatment temperature, the heat treatment time, the weight increase, the thickness of the silica layer, and the NOx conversion efficiency, with respect to the honeycomb catalyst bodies manufactured in Examples 1 to 6 and Comparative Examples 1 and 2.

FIG. 4 shows a graph indicating a relation between the thickness of the silica layer and the NOx conversion efficiency in each Example and Comparative Example, based on the measurement results in Examples 1 to 6 and Comparative Examples 1 and 2.

TABLE 1

| | | | | | NOx |
|---|---|---|---|---|---|
| | Heat treatment | | Weight | Thickness | conversion |
| | Temperature | Time | increase | of silica | efficiency |
| | (° C.) | (hr) | (% by weight) | layer (nm) | (%) |
| Example 1 | 700 | 3 | 0.06 | 8 | 62 |
| Example 2 | 900 | 10 | 0.20 | 26 | 66 |
| Example 3 | 1000 | 3 | 0.25 | 36 | 70 |
| Example 4 | 1100 | 1 | 0.30 | 45 | 74 |
| Example 5 | 1100 | 3 | 0.33 | 65 | 68 |
| Example 6 | 1100 | 4 | 0.49 | 95 | 60 |
| Compar- | — | — | 0 | <4 | 48 |
| ative | | | | | |
| Example 1 | | | | | |
| Compar- | 1100 | 5 | 0.56 | 109 | 52 |
| ative | | | | | |
| Example 2 | | | | | |

The measurement results of the weight increase indicate that the oxidation process leads to an increase in the weight of the honeycomb fired body.

The measurement results of the thickness of the silica layer by X-ray photoelectron spectroscopy (XPS) confirm formation of a silica layer (from 8 nm to 109 nm in thickness) in each honeycomb catalyst bodies of Examples 1 to 6 and Comparative Example 2 in which the oxidation process was carried out. In contrast, in the honeycomb catalyst body manufactured in Comparative Example 1 in which the oxidation process was not carried out, the thickness of the silica layer was less than 4 nm which indicates that an effective silica layer was not formed. FIG. 4 indicates the thickness of the silica layer of Comparative Example 1 as 0 nm for the convenience.

As above, it is presumable that the weight increase by the oxidation process can be considered as the weight ratio of the silica layer in the honeycomb fired body.

The measurement results of the NOx conversion efficiency indicate that the NOx conversion efficiency was high as from 60% to 74% in the case that the thickness of the silica layer was from 8 nm to 95 nm as in Examples 1 to 6. In contrast, in the case that no effective silica layer was formed as in Comparative Example 1 and in the case that the silica layer was thick as 109 nm as in Comparative Example 2, the NOx conversion efficiency was low as 48% and 52%, respectively.

The above results indicate that control of the thickness of the silica layer within a predetermined range (from about 5 nm to about 100 nm, preferably from about 8 nm to about 95 nm) is likely to improve the NOx conversion efficiency. Accordingly, control of the thickness of the silica layer within a predetermined range presumably allows zeolite to be likely to be substantially uniformly supported on the surface of each of the silicon carbide particles, which is likely to lead to improvement in the NOx conversion efficiency.

Here, it is presumable that the kind of the catalyst does not significantly affect the condition of the catalyst supported on the surface of each of the silicon carbide particles. Accordingly, even in the case that the catalyst is not zeolite but oxide ceramics such as Al₂O₃, control of the thickness of the silica layer within a predetermined range presumably allows the catalyst to be likely to be substantially uniformly supported on the surface of each of the silicon carbide particles.

Therefore, the conversion efficiency of toxic components such as CO and HC contained in exhaust gases is likely to be presumably improved by using oxide ceramics supporting a noble metal or alkaline earth metal thereon, in the same way as the NOx conversion efficiency improved by zeolite.

### Second Embodiment

Now, a description is given on a second embodiment that is one embodiment of the present invention.

In the present embodiment, a honeycomb structure configuring the honeycomb catalyst body has a single honeycomb fired body. Such a honeycomb structure having a single honeycomb fired body is referred to as an integral honeycomb structure.

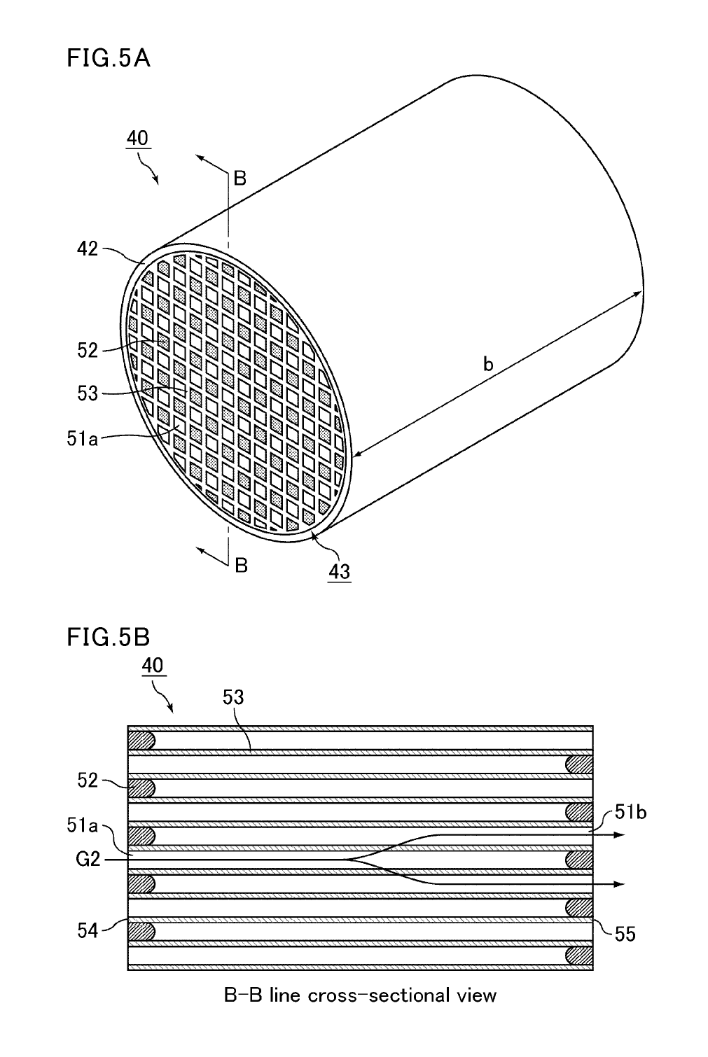

FIG. 5A is a schematic perspective view illustrating one example of a honeycomb structure configuring a honeycomb catalyst body of the second embodiment of the present invention. FIG. 5B is a B-B line cross-sectional view of the honeycomb structure in FIG. 5A.

A honeycomb structure 40 shown in FIGS. 5A and 5B has a ceramic block 43 including a single substantially round pillar-shaped honeycomb fired body having a large number of cells 51a and 51b longitudinally (direction of arrow “b” in FIG. 5A) placed in parallel with one another with a cell wall 53 interposed therebetween. On the periphery of the ceramic block 43, a coat layer 42 is formed. Here, a coat layer may be formed according to need.

In the honeycomb structure 40, either one end portion of each of the cells 51a and 51b is plugged with a plug material 52. Therefore, exhaust gases G2 (in FIG. 5B, exhaust gases are represented by “G2” and a flow thereof is indicated by arrows) which have flowed into one of the cells 51a with an opening on one end face 54 surely pass through the cell wall 53 that partitions the cells 51a and the cells 51b with an opening on the other end face 55, and flow out from one of the cells 51b. Thus, the cell wall 53 functions as a filter for capturing PM and the like.

The honeycomb fired body configuring the honeycomb structure is mainly made of silicon carbide particles, which is similar to the first embodiment of the present invention. Specifically, the honeycomb fired body contains about 60% by weight or more of silicon carbide.

The honeycomb fired body may contain other components, provided that about 60% by weight or more of silicon carbide is contained. For example, the honeycomb fired body may contain about 40% by weight or less of silicon. The main component of the materials for forming the honeycomb fired body may be silicon-containing silicon carbide that is silicon carbide blended with metal silicon or may be silicon carbide bound with silicon or a silicate compound.

In the honeycomb catalyst body of the present embodiment, a catalyst containing oxide ceramics or zeolite is supported on such a honeycomb structure. The catalyst is preferably supported on cell walls in the honeycomb fired body configuring the honeycomb structure.

In the same manner as in the first embodiment of the present invention, a silica layer is formed on each of the surfaces of the silicon carbide particles forming the honeycomb fired body. Moreover, the catalyst is supported on the surface of each of the silicon carbide particles via the silica layer therebetween.

The honeycomb catalyst body of the present embodiment is similar to the honeycomb catalyst body of the first embodiment of the present invention, with respect to the kind and thickness of the silica layer, the kind of the catalyst, the condition of the catalyst supported, the average particle size of the catalyst, and the amount of the oxide ceramics or zeolite supported on the honeycomb structure (cell walls).

In manufacturing of a honeycomb structure configuring the honeycomb catalyst body of the embodiment, a honeycomb molded body is manufactured in the same way as in the first embodiment of the present invention, except that the honeycomb molded body formed by extrusion molding has a larger size compared to the honeycomb molded body described in the first embodiment of the present invention and has an outer shape different from that of the honeycomb molded body of the first embodiment of the present invention.

Other processes are similar to those for manufacturing the honeycomb structure in the first embodiment of the present invention. It is to be noted that a bonding process is not needed as the honeycomb structure of the second embodiment of the present invention has a single honeycomb fired body. Moreover, it is to be noted that a periphery cutting process is not needed for the honeycomb structure of the second embodiment of the present invention.

The oxidation process (process of forming a silica layer on the surface of each of the silicon carbide particles in the honeycomb fired body) and the supporting process (process of forming a layer supporting zeolite or the like as a catalyst) described in the first embodiment of the present invention are carried out to the honeycomb structure manufactured as above. In this manner, the honeycomb catalyst body according to the second embodiment of the present invention is manufactured.

In a method for manufacturing the honeycomb catalyst body of the present embodiment, the oxidation process may be carried out after the coat layer forming process. In the case where the periphery cutting process is carried out, the oxidation process may be carried out between the firing process and the periphery cutting process, or between the periphery cutting process and the coat layer forming process. On the other hand, in the case that the periphery cutting process is not carried out, the oxidation process may be carried out between the firing process and the coat layer forming process.

In addition, the honeycomb structure to be oxidized is not limited to the honeycomb structure manufactured in the above processes, and may be any integral honeycomb structure. For example, the oxidation process may be carried out to a honeycomb structure in which a coat layer is not formed.

The effects (1) to (3) described in the first embodiment of the present invention can be exerted also in the honeycomb catalyst body and the method for manufacturing the honeycomb catalyst body of the present embodiment.

### Other Embodiments

In the case that a honeycomb catalyst body is manufactured by using an aggregated honeycomb structure, a catalyst containing oxide ceramics or zeolite is supported on a honeycomb structure in the first embodiment of the present invention. However, the catalyst may be supported on a honeycomb fired body and a plurality of the honeycomb fired bodies supporting the catalyst thereon may be bonded to one another with an adhesive layer interposed therebetween.

In the honeycomb catalyst body of the embodiment of the present invention, the shape of the honeycomb structure is not limited to substantially round pillar shape, but may be any pillar shape such as substantially cylindroid pillar shape and substantially polygonal pillar shape.

In the honeycomb catalyst body of the embodiment of the present invention, the porosity of the honeycomb fired body configuring the honeycomb structure is not particularly limited, and is preferably from about 35% to about 70%.

When the porosity of the honeycomb fired body is about 35% or more, particulates (PM) is less likely to cause clogging in the honeycomb fired body. On the other hand, when the porosity of the honeycomb fired body is about 70% or less, the strength of the honeycomb fired body is less likely to be lowered, which is less likely to lead to easy breakage.

In the honeycomb catalyst body of the embodiment of the present invention, the average pore size of the honeycomb fired body configuring the honeycomb structure is preferably from about 5 μm to about 30 μm.

When the average pore size of the honeycomb fired body is about 5 μm or more, particulates are less likely to cause clogging in the honeycomb fired body. On the other hand, when the average pore size of the honeycomb fired body is about 30 μm or less, particulates are less likely to pass through the pores in the cell walls. In such a case, the honeycomb fired body can certainty capture particulates, which is less likely to result in insufficient performance as a filter.

The porosity and the pore size may be measured by mercury porosimetry that is a conventionally known method.

The thickness of the cell walls in the honeycomb fired body is not particularly limited, and is preferably from about 0.12 mm to about 0.40 mm.

When the thickness of the cell wall is about 0.12 mm or more, the cell walls are thick, and therefore the strength of the honeycomb fired body is easily maintained. On the other hand, when the thickness of the cell wall is about 0.40 mm or less, the pressure loss of the honeycomb structure is less likely to increase.

The cell density in a cross section perpendicular to the longitudinal direction of the honeycomb fired body is not particularly limited. Preferably, the lower limit is about 31.0 pcs/cm² (about 200 pcs/inch²) and the upper limit is about 93.0 pcs/cm² (about 600 pcs/inch²). More preferably, the lower limit is about 38.8 pcs/cm² (about 250 pcs/inch²) and the upper limit is about 77.5 pcs/cm² (about 500 pcs/inch²).

In the honeycomb catalyst body of the embodiment of the present invention, the shape of each of cells in a cross section perpendicular to the longitudinal direction of the honeycomb fired body is not limited to a substantial quadrangle, and may be any shape such as substantially circular, substantially elliptical, substantially pentagonal, substantially hexagonal, substantially trapezoidal, and substantially octagonal shapes. Moreover, various shapes may be employed in combination.

The bonding process in manufacture of an aggregated honeycomb structure may be carried out by temporarily fixing honeycomb fired bodies in a mold having the same shape as a ceramic block (or an aggregate of honeycomb fired bodies) to be manufactured and injecting an adhesive paste to the gap between the honeycomb fired bodies, in addition to a method of applying an adhesive paste on side faces of each honeycomb fired body.

In manufacturing of an aggregated honeycomb structure, a plurality of kinds of honeycomb fired bodies having various cross-sectional shapes may be manufactured. Then, the plurality of kinds of honeycomb fired bodies may be combined to form a ceramic block in which a plurality of honeycomb fired bodies are bonded to one another with an adhesive layer interposed therebetween. In such a case, the periphery cutting process may be omitted.

For example, three kinds of honeycomb fired bodies different in the cross-sectional shape may be manufactured. A first honeycomb fired body has a cross section surrounded by two lines and one substantial arc. A second honeycomb fired body has a cross section surrounded by three lines and one substantial arc. A third honeycomb fired body has a cross section surrounded by four lines (substantial quadrangle). These three kinds of honeycomb fired bodies different in the cross-sectional shape may be manufactured by changing the shape of the die used in extrusion molding. A substantially round pillar-shaped honeycomb structure may be manufactured by combining eight pieces of the first honeycomb fired bodies, four pieces of the second honeycomb fired bodies, and four pieces of the third honeycomb fired bodies.

In the honeycomb catalyst body of the embodiment of the present invention, the organic binder contained in the wet mixture used for manufacturing a honeycomb fired body configuring the honeycomb structure is not particularly limited. Examples thereof include methyl cellulose, carboxy methyl cellulose, hydroxyl ethyl cellulose, polyethylene glycol, and the like. Among these, methyl cellulose is preferable. Commonly, the amount of the organic binder is preferably from about 1 part by weight to about 10 parts by weight for each 100 parts by weight of ceramic powder.

The plasticizer contained in the wet mixture is not particularly limited, and may be glycerin and the like.

Moreover, the lubricant contained in the wet mixture is not particularly limited, and examples thereof include polyoxyalkylene compounds such as polyoxyethylene alkyl ether and polyoxypropylene alkyl ether, and the like.

Specific examples of the luburicant include polyoxyethylene monobutyl ether, polyoxypropylene monobutyl ether, and the like.

In some cases, the wet mixture may contain no plasticizer and no lubricant.

In preparing the wet mixture, a dispersion medium may be used. Examples of the dispersion medium include water, organic solvents such as benzene, alcohols such as methanol, and the like.

The wet mixture may further contain a molding aid.

The molding aid is not particularly limited, and examples thereof include ethylene glycol, dextrin, fatty acid, fatty acid soap, polyalcohol, and the like.

The wet mixture may further contain a pore forming agent such as balloons that are micro hollow spheres containing oxide ceramics, spherical acrylic particles, and graphite, if needed.

The balloons are not particularly limited, and examples thereof include alumina balloons, glass micro balloons, shirasu balloons, Fly ash balloons (FA balloons), mullite balloons, and the like. Among these, alumina balloons are preferable.

Examples of the inorganic binder contained in the adhesive paste and the coat material paste include silica sol, alumina sol, and the like. Each of these may be used alone, or two or more of these may be used in combination. Among the inorganic binders, silica sol is preferable.

Examples of the organic binder contained in the adhesive paste and the coat material paste include polyvinyl alcohol, methyl cellulose, ethyl cellulose, carboxy methyl cellulose, and the like. Each of these may be used alone, or two or more of these may be used in combination. Among the organic binders, carboxy methyl cellulose is preferable.

Examples of the inorganic fibers contained in the adhesive paste and the coat material paste include fibers of ceramics such as silica-alumina, mullite, alumina, and silica. Each of these may be used alone, or two or more of these may be used in combination. Among the inorganic fibers, alumina fibers are preferable.

Examples of the inorganic particles contained in the adhesive paste and the coat material paste include carbide particles, nitride particles, and the like. More specifically, the examples may include silicon carbide particles, silicon nitride particles, boron nitride particles, and the like. Each of these may be used alone, or two or more of these may be used in combination. Among the inorganic particles, silicon carbide particles are preferable because of its excellent thermal conductivity.

The adhesive paste and the coat material paste may further contain a pore forming agent such as balloons that are micro hollow spheres containing oxide ceramics, spherical acrylic particles, and graphite, if needed. The balloons are not particularly limited, and examples thereof include alumina balloons, glass micro balloons, shirasu balloons, Fly ash balloons (FA balloons), mullite balloons, and the like. Among these, alumina balloons are preferable.

Examples of the catalyst component other than the oxide ceramics and zeolite in the honeycomb catalyst body of the embodiment of the present invention include: noble metals such as platinum, palladium, and rhodium; alkali metals such as potassium and sodium; and alkaline earth metals such as barium. Among these, platinum is preferable.

In the honeycomb structure in the honeycomb catalyst body of the embodiment of the present invention, end portions of each cell may not be plugged with a plug. In such a case, a catalyst is supported on the honeycomb structure and the honeycomb structure serves as a catalyst carrier for converting toxic gas components such as CO, HC, and NOx contained in exhaust gases.

Essential features of the honeycomb catalyst body of the embodiment of the present invention are a silica layer formed on the surface of each of the silicon carbide particles, a catalyst containing oxide ceramics or zeolite supported on the surface of each of the silicon carbide particles via a silica layer therebetween, a thickness of the silica layer measured by X-ray photoelectron spectroscopy (XPS) being from about 5 nm to about 100 nm, and oxide ceramics or zeolite being supported in an amount of about 50 g/L or more. The method for manufacturing a honeycomb catalyst body of the embodiment of the present invention essentially has an oxidation process for oxidizing a honeycomb structure by heat treatment under an oxidative atmosphere at from about 700° C. to about 1100° C. for from about 1 hour to about 10 hours and a supporting process for supporting a catalyst containing oxide ceramics or zeolite after the oxidation process. The oxidation process essentially includes formation of a silica layer having a thickness measured by X-ray photoelectron spectroscopy (XPS) being from about 5 nm to about 100 nm on the surface of each of the silicon carbide particles contained in the honeycomb fired body, and the supporting process essentially includes supporting the oxide ceramics or zeolite in an amount of about 50 g/L or more.

Desired effects can be obtained by an appropriate combination of these essential features with various configurations (e.g. components of honeycomb fired body, kind of catalyst, conditions for oxidation process, etc.) described in the first embodiment, the second embodiment, and other embodiments of the present invention.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A honeycomb catalyst body comprising:
a honeycomb structure including a porous honeycomb fired body having at least one cell wall defining a plurality of cells extending along a longitudinal direction of the porous honeycomb fired body, the plurality of cells being provided in parallel with one another, the honeycomb fired body containing silicon carbide particles and a silica layer formed on a surface of each of the silicon carbide particles, the silica layer having a thickness of from about 5 nm to about 100 nm measured by X-ray photoelectron spectroscopy; and
a catalyst containing at least one of oxide ceramics and zeolite, the catalyst being provided on a surface of the silica layer, an amount of at least one of the oxide ceramics and the zeolite being about 50 g/L or more.

2. The honeycomb catalyst body according to claim 1,
wherein
at least one of the oxide ceramics and the zeolite is provided inside the cell wall of the honeycomb fired body.

3. The honeycomb catalyst body according to claim 1,
wherein
the honeycomb structure has a single honeycomb fired body.

4. The honeycomb catalyst body according to claim 1,
wherein
the honeycomb structure has a plurality of honeycomb fired bodies bound to one another with an adhesive layer interposed between the honeycomb fired bodies.

5. The honeycomb catalyst body according to claim 1,
wherein
the honeycomb catalyst body is used in a urea-SCR device.

6. The honeycomb catalyst body according to claim 1,
wherein
the honeycomb structure comprises:
a ceramic block including at least one of honeycomb fired bodies; and
a coat layer formed on a periphery of the ceramic block.

7. The honeycomb catalyst body according to claim 1,
wherein
either one end portion or another end portion of each of the cells is plugged.

8. The honeycomb catalyst body according to claim 1,
wherein
the honeycomb fired body comprises a plurality of silicon carbide particles serving as aggregates, the plurality of silicon carbide particles being bound to one another with a plurality of fine pores kept between silicon carbide particles.

9. The honeycomb catalyst body according to claim 1,
wherein
a main component of materials forming the honeycomb fired body is
silicon-containing silicon carbide that is silicon carbide blended with metal silicon,
silicon carbide bound with silicon, or
silicon carbide bound with a silicate compound.

10. The honeycomb catalyst body according to claim 1,
wherein
the silica layer has a thickness of from about 8 nm to about 95 nm.

11. The honeycomb catalyst body according to claim 1,
wherein
a weight ratio of the silica layer is from about 0.06% by weight to about 0.49% by weight in the honeycomb structure or the honeycomb fired body.

12. The honeycomb catalyst body according to claim 1,
wherein
the oxide ceramics comprises at least one of Al₂O₃, ZrO₂, TiO₂, and CeO₂.

13. The honeycomb catalyst body according to claim 12,
wherein
the oxide ceramics comprises at least one of Al₂O₃ and CeO₂.

14. The honeycomb catalyst body according to claim 1,
wherein
the zeolite comprises at least one of β-type zeolite, Y-type zeolite, ferrierite, ZSM-5 type zeolite, mordenite, faujasite, A-type zeolite, L-type zeolite, SAPO, and MeAPO.

15. The honeycomb catalyst body according to claim 1,
wherein
the zeolite is obtained by ion exchange using a metal ion.

16. The honeycomb catalyst body according to claim 15,
wherein
the metal ion comprises at least one of copper ion, iron ion, nickel ion, zinc ion, manganese ion, cobalt ion, silver ion, and vanadium ion.

17. The honeycomb catalyst body according to claim 1,
wherein
at least one of the oxide ceramics and the zeolite is provided on the honeycomb structure in an amount of from about 50 g/L to about 150 g/L.

18. The honeycomb catalyst body according to claim 17,
wherein
at least one of the oxide ceramics and the zeolite is provided on the honeycomb structure in an amount of from about 80 g/L to about 150 g/L.

19. The honeycomb catalyst body according to claim 1,
wherein
at least one of the oxide ceramics and the zeolite has an average particle size of from about 0.5 μm to about 5 μm.

20. The honeycomb catalyst body according to claim 1,
wherein
at least one of a noble metal and an alkaline earth metal is provided on the oxide ceramics.

21. A method for manufacturing a honeycomb catalyst body, comprising:
oxidizing a honeycomb structure including a porous honeycomb fired body by heating under an oxidative atmosphere at from about 700° C. to about 1100° C. for from about 1 hour to about 10 hours, the honeycomb fired body having at least one cell wall defining a plurality of cells extending along a longitudinal direction of the porous honeycomb fired body, the plurality of cells being provided in parallel with one another, the oxidizing of the honeycomb structure including forming a silica layer on a surface of each of silicon carbide particles contained in the honeycomb fired body, the silica layer having a thickness of from about 5 nm to about 100 nm measured by X-ray photoelectron spectroscopy; and
treating the oxidized honeycomb structure with a supporting process so that a catalyst containing at least one of oxide ceramics and zeolite is provided on the oxidized honeycomb structure, an amount of at least one of the oxide ceramics and the zeolite being about 50 g/L or more.

22. The method for manufacturing a honeycomb catalyst body according to claim 21,
wherein
an oxidative atmosphere in the oxidizing of the honeycomb structure has an oxygen concentration of from about 5% by volume to about 21% by volume.

23. The method for manufacturing a honeycomb catalyst body according to claim 21, further comprising:
bonding a plurality of honeycomb fired bodies via an adhesive layer between the plurality of honeycomb fired bodies.

24. The method for manufacturing a honeycomb catalyst body according to claim 21,
wherein
the oxidizing of the honeycomb structure is carried out under an atmosphere containing oxygen.

25. The method for manufacturing a honeycomb catalyst body according to claim 21,
wherein
in the oxidizing of the honeycomb structure, when a heat treatment temperature is about 700° C. or more and is less than about 850° C., a heat treatment time is from about 3 hours to about 12 hours, when a heat treatment temperature is about 850° C. or more and is less than about 950° C., a heat treatment time is from about 2 hours to about 10 hours, or when a heat treatment temperature is about 950° C. or more and is less than about 1100° C., a heat treatment time is from about 0.5 hour to about 4.5 hours.

26. The method for manufacturing a honeycomb catalyst body according to claim 21, further comprising:
forming a coat layer on a periphery of a ceramic block including at least one of honeycomb fired bodies,
wherein the oxidizing of the honeycomb structure is carried out after the forming of the coat layer.

27. The method for manufacturing a honeycomb catalyst body according to claim 23, further comprising:
cutting a ceramic block including a plurality of honeycomb fired bodies; and
forming a coat layer on a periphery of the ceramic block,
wherein the oxidizing of the honeycomb structure is carried out between the bonding of the honeycomb fired bodies and the cutting of the ceramic block or between the cutting of the ceramic block and the forming of the coat layer.

28. The method for manufacturing a honeycomb catalyst body according to claim 21, further comprising:
firing at least one of honeycomb bodies to produce at least one of honeycomb fired bodies; and
forming a coat layer on a periphery of a ceramic block including at least one of the honeycomb fired bodies,
wherein the oxidizing of the honeycomb structure is carried out between the firing of at least one of the honeycomb bodies and the forming of the coat layer.

29. The method for manufacturing a honeycomb catalyst body according to claim 21,
wherein
either one end portion or another end portion of each of the cells is plugged.

30. The method for manufacturing a honeycomb catalyst body according to claim 21,
wherein
the honeycomb fired body comprises a plurality of silicon carbide particles serving as aggregates, the plurality of silicon carbide particles being bound to one another with a plurality of fine pores kept between silicon carbide particles.

31. The method for manufacturing a honeycomb catalyst body according to claim 21,
wherein
a main component of materials forming the honeycomb fired body is
silicon-containing silicon carbide that is silicon carbide blended with metal silicon,
silicon carbide bound with silicon, or
silicon carbide bound with a silicate compound.

32. The method for manufacturing a honeycomb catalyst body according to claim 21,
wherein
the silica layer has a thickness of from about 8 nm to about 95 nm.

33. The method for manufacturing a honeycomb catalyst body according to claim 21,
wherein
a weight ratio of the silica layer is from about 0.06% by weight to about 0.49% by weight in the honeycomb structure or the honeycomb fired body.

34. The method for manufacturing a honeycomb catalyst body according to claim 21,
wherein
the oxide ceramics comprises at lease one of Al₂O₃, ZrO₂, TiO₂, and CeO₂.

35. The method for manufacturing a honeycomb catalyst body according to claim 34,
wherein
the oxide ceramics comprises at least one of Al₂O₃ and CeO₂.

36. The method for manufacturing a honeycomb catalyst body according to claim 21,
wherein
the zeolite comprises at least one of β-type zeolite, Y-type zeolite, ferrierite, ZSM-5 type zeolite, mordenite, faujasite, A-type zeolite, L-type zeolite, SAPO, and MeAPO.

37. The method for manufacturing a honeycomb catalyst body according to claim 21,
wherein
the zeolite is obtained by ion exchanged using a metal ion.

38. The method for manufacturing a honeycomb catalyst body according to claim 37,
wherein
the metal ion comprises at least one of copper ion, iron ion, nickel ion, zinc ion, manganese ion, cobalt ion, silver ion, and vanadium ion.

39. The method for manufacturing a honeycomb catalyst body according to claim 21,
wherein
in the supporting process, at least one of the oxide ceramics and the zeolite is provided on the honeycomb structure in an amount of from about 50 g/L to about 150 g/L.

40. The method for manufacturing a honeycomb catalyst body according to claim 39,
wherein
in the supporting process, at least one of the oxide ceramics and the zeolite is provided on the honeycomb structure in an amount of from about 80 g/L to about 150 g/L.

41. The method for manufacturing a honeycomb catalyst body according to claim 21,
wherein
at least one of the oxide ceramics and the zeolite has an average particle size of from about 0.5 μm to about 5 μm.

42. The method for manufacturing a honeycomb catalyst body according to claim 21,
wherein
at least one of a noble metal and an alkaline earth metal is provided on the oxide ceramics.
